(19) United States
(12) Patent Application Publication
(10) Pub. No.: US 2025/0004446 A1
(43) Pub. Date: Jan. 2, 2025

(54) PROGRAM TEACHING ASSISTANCE DEVICE

(71) Applicant: FANUC CORPORATION, Minamitsuru-gun, Yamanashi (JP)

(72) Inventor: Daiki YAMAGUCHI, Yamanashi (JP)

(21) Appl. No.: 18/709,683

(22) PCT Filed: Dec. 20, 2021
(86) PCT No.: PCT/JP2021/046948

§ 371 Date: May 13, 2024

(51) Int. Cl. G05B 19/4155

(52) U.S. Cl. CPC G05B 19/4155; G05B 2219/39384

(57) ABSTRACT

The present invention enables even an inexperienced user to easily adjust the time taken to reach a target position in a program. This program teaching assistance device comprises a display unit that displays an operating time of an industrial machine which is calculated for each command of a program and/or in the order of commands, in such a manner as to arrange blocks, the lengths of which are variable in the direction of the operating time.

### TECHNICAL FIELD

The present invention relates to a program teaching assistance device.

### BACKGROUND ART

A target position is first designated in a robot program, which teaches the instruction to allow a robot to move to the position. The need arises to examine the time taken to reach the target position as well as to confirm that the target position can be reached.

In this regard, state information and timing information are acquired, time-series information is generated based on the acquired state information and timing information, and while timings indicated by the timing information are matched, a plurality of items of the time-series information are superimposed and displayed. The state information indicates the operating state of a machine tool that executes a machining program including a plurality of blocks identifiable by sequence numbers in terms of the amount of change and the time axis. The timing information indicates predetermined timings for the machining program executed by the machine tool. See Patent Document 1, for example. Citation List Patent Document
Patent Document 1: Japanese Unexamined Patent Application, Publication No. 2019-13334

### DISCLOSURE OF THE INVENTION

### Problems to be Solved by the Invention

In the case of the robot program and the machining program, the time taken to reach the target position varies depending on the details of the instruction. Reaching the target position at the user's intended time requires repetitions of changing instructions and parameters and further executing the changed program. An expert, who is experienced and has the know-how, can teach a robot by rough estimation, and can correct a machining program for a machine tool. Unfortunately, a user who is inexperienced in teaching a robot and in editing a machining program cannot determine which value should be changed. Thus, it takes time to teach the robot and to edit the machining program.

In addition, when the robot program is to be taught and corrected, the entire program has not been displayed using time as an axis, and no simple process has been developed to correct the program using time as an axis.

To address these problems, an inexperienced user is also expected to be able to easily adjust the time taken to reach the target position in the program.

### Means for Solving the Problems

A program teaching assistance device of the present disclosure includes: a display unit configured to display an operating time of an industrial machine calculated on each of instructions and/or in instruction order in a program in the form of arranged blocks whose length of the operating times is variable.

### Effects of the Invention

According to an aspect, an inexperienced user can also easily adjust the time taken to reach a target position through a program.

### BRIEF DESCRIPTION OF THE DRAWINGS

FIG. 1 is a functional block diagram showing an exemplary functional configuration of a machine system according to an embodiment;

FIG. 2 illustrates an example of a screen displayed on a display unit;

FIG. 3A illustrates an example of how the length of a block is changed on the screen illustrated in FIG. 2;

FIG. 3B illustrates an example of how the length of a block is changed on the screen illustrated in FIG. 2;

FIG. 4 illustrates an example of a block indicating the operating time closest to the calculated operating time; and

FIG. 5 is a flowchart illustrating a teaching assistance process to be performed by a program teaching assistance device.

### PREFERRED MODE FOR CARRYING OUT THE INVENTION

An embodiment will be described below with reference to the drawings.

### Embodiment

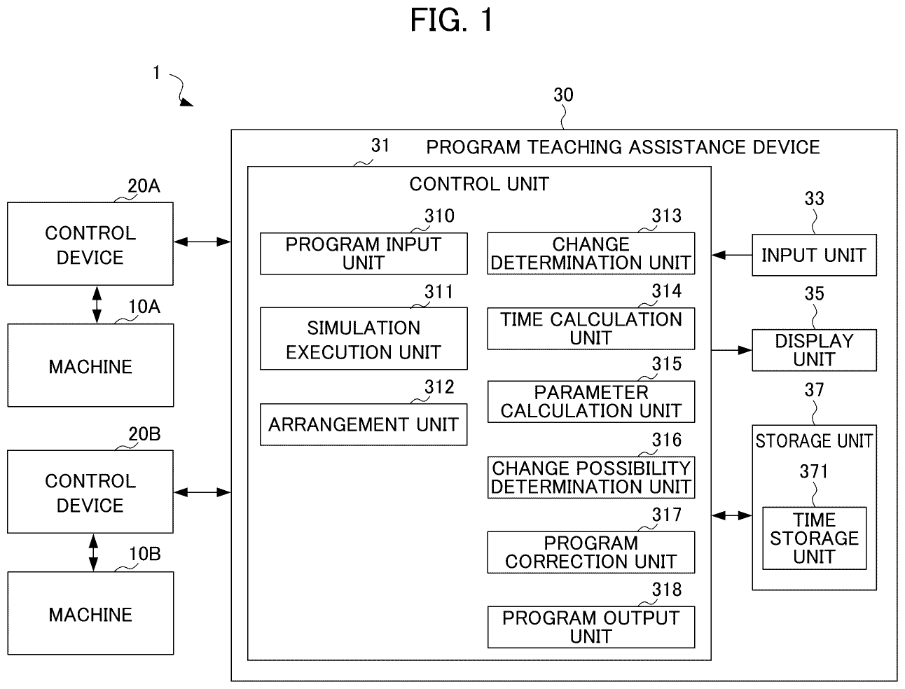

FIG. 1 is a functional block diagram showing an exemplary functional configuration of a machine system according to an embodiment. As shown in FIG. 1, a machine system 1 includes two machines 10A and 10B, two control devices 20A and 20B, and a program teaching assistance device 30. In this embodiment, the machines 10A and 10B serving as robots and the control devices 20A and 20B serving as robot control devices are exemplified. The machines 10A and 10B according to the present invention should not be limited to robots. The present invention is applicable also to industrial machines, such as machine tools, conveyors, presses, and injection molding machines. The control devices 20A and 20B according to the present invention should not be limited to robot control devices. The present invention is applicable also to numerical control devices that control machine tools and any other similar tools.

The machines 10A and 10B, the control devices 20A and 20B, and the program teaching assistance device 30 may be directly connected together via a connection interface (not shown). The machines 10A and 10B, the control devices 20A and 20B, and the program teaching assistance device 30 may be connected to one another via a network, such as a local area network (LAN). In this case, the machines 10A and 10B, the control devices 20A and 20B, and the program teaching assistance device 30 may each include a communication unit (not shown) for allowing them to communicate with one another.

### <Machines 10A and 10B>

Examples of the machines 10A and 10B include industrial machines, such as machine tools and industrial robots. The machines 10A and 10B will be described below in the form of industrial robots (hereinafter referred to also as the “robots 10A and 10B”).

If there is no need to distinguish the robots 10A and 10B from each other, these robots are collectively referred to also as the “robots 10”.

### <Control Devices 20A and 20B>

The control devices 20A and 20B are robot control devices that are well known to those skilled in the art, each generate a command based on a robot program generated by a user teaching the associated robot 10A, 10B, and each transmit the generated command to the robot 10A, 10B. In this manner, the control devices 20A and 20B control operations of the robots 10A and 10B, respectively.

If there is no need to distinguish the control devices 20A and 20B from each other, these control devices are collectively referred to also as the “control devices 20”.

### <Program Teaching Assistance Device 30>

The program teaching assistance device 30, which is a computer or any other similar device, acquires a program from each control device 20 to adjust the operating time of the associated robot 10 in response to input from the user, and corrects the acquired program.

The program teaching assistance device 30 is connected to the control devices 20A and 20B, but may be connected to one or three or more control devices 20.

As shown in FIG. 1, the program teaching assistance device 30 includes a control unit 31, an input unit 33, a display unit 35, and a storage unit 37. The control unit 31 includes a program input unit 310, a simulation execution unit 311, an arrangement unit 312, a change determination unit 313, a time calculation unit 314, a parameter calculation unit 315, a change possibility determination unit 316, a program correction unit 317, and a program output unit 318.

The input unit 33 is configured as an input device, such as a keyboard or a touch panel, and accepts various inputs from the user.

The display unit 35 is a display device, such as a liquid crystal display (LCD). The display unit 35 displays a screen where different operating times of the robots 10 for different instructions in the associated programs are arranged, by the arrangement unit 312, on an instruction-by-instruction basis and/or in instruction order in the form of blocks whose length of the associated operating time is variable. The different operating times have been determined from a simulation of the associated program executed by the simulation execution unit 311, as will be described later.

The storage unit 37 is a solid state drive (SSD), a hard disk drive (HDD), or any other similar device. The storage unit 37 stores an operating system and an application program to be executed by the control unit 31, for example, which will be described later. The storage unit 37 further stores the program (robot program) acquired from each control device 20. The storage unit 37 includes a time storage unit 371.

The time storage unit 371 stores the different operating times of the robots 10 for the different instructions in the associated programs that have been determined from a simulation of the associated program executed by the simulation execution unit 311, in the form of simulation results, as will be described later.

### <Control Unit 31>

The control unit 31 includes a central processing unit (CPU), a read-only memory (ROM), a random access memory (RAM), and a CMOS memory, which are capable of communicating with one another via a bus. Such a control unit is well known to those skilled in the art.

The CPU is a processor that controls the program teaching assistance device 30 as a whole. The CPU reads a system program and an application program stored in the ROM via the bus, and controls the entire program teaching assistance device 30 in accordance with the system program and the application program. Thus, as shown in FIG. 1, the control unit 31 is configured to implement the functions of the program input unit 310, the simulation execution unit 311, the arrangement unit 312, the change determination unit 313, the time calculation unit 314, the parameter calculation unit 315, the change possibility determination unit 316, the program correction unit 317, and the program output unit 318. The RAM stores various types of data, such as temporary calculation data and display data. The CMOS memory is backed up by a battery (not shown), and is configured as a nonvolatile memory that retains its memory state even with the program teaching assistance device 30 turned off.

The program input unit 310 loads a program (a robot program) to be simulated by the simulation execution unit 311 as will be described later from the associated control device 20.

The simulation execution unit 311 simulates the program loaded by the program input unit 310 using a known technique, for example. The simulation execution unit 311 makes the time storage unit 371 store different operating times of the robots 10 for different instructions in the associated programs on a robot-10-by-robot-10 basis. The different operating times have been determined by the simulation.

The arrangement unit 312 arranges the blocks along the time axis on an instruction-by-instruction basis and/or in instruction order in the associated programs, based on the operating times stored in the time storage unit 371, for example. The blocks each indicate the operating time of the robot 10 under the associated instruction. The arrangement unit 312 makes the display unit 35 display a screen showing the arranged blocks.

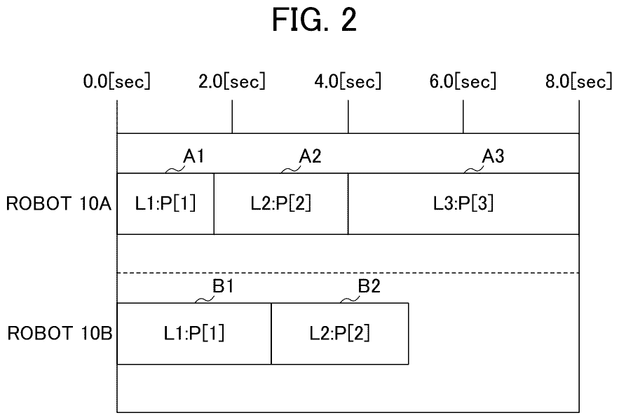

FIG. 2 illustrates an example of a screen displayed on the display unit 35.

As illustrated in FIG. 2, the screen displayed on the display unit 35 has a horizontal axis corresponding to the time axis, and shows the operating times of each of the robots 10A and 10B under the associated instructions in the associated programs (robot programs), which are the simulation results of the simulation execution unit 311, in the form of the blocks arranged by the arrangement unit 312. Specifically, the program (robot program) for the robot 10A has three instructions L1 to L3 (teaching points P[1] to P[3]), and the screen illustrated in FIG. 2 shows the operating time of the robot 10A under each of the instructions L1 to L3 in the form of blocks A1 to A3 arranged along the time axis. The program (robot program) for the robot 10B has two instructions L1 and L2 (teaching points P[1] and P[2]), and the screen illustrated in FIG. 2 shows the operating time of the robot 10B under each of the instructions L1 and L2 in the form of blocks B1 and B2 arranged along the time axis.

Note that the time axis does not always need to be the horizontal axis. The time axis may be oriented in the vertical direction or in an optional direction, for example. In this case, the blocks are arranged along the time axis.

The change determination unit 313 determines whether or not the length of the block that indicates the operating time of any one of the robots 10 and that are displayed on the display unit 35 has been changed, for example.

For example, if the user intends to handle a workpiece from the robot 10A to the robot 10B, the programs (robot program) loaded by the program input unit 310 show the difference between the time when the robot 10A reaches the teaching point P[3] and the time when the robot 10B reaches the teaching point P[2] as illustrated in FIG. 2.

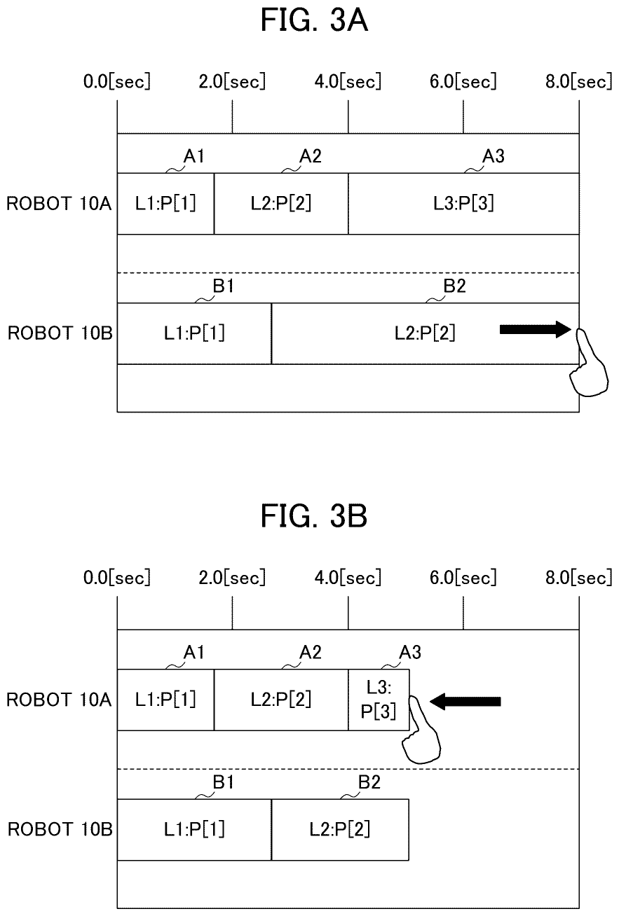

To address this problem, the user inputs the indication to increase the length of the block B2 for the robot 10B (the operating time of the robot 10B under the instruction L2) on the screen displayed on the display unit 35 using the input unit 33 so that the time when the robot 10A reaches the teaching point P[3] and the time when the robot 10B reaches the teaching point P[2] match each other, as illustrated in FIG. 3A, for example. Alternatively, the user may input the indication to reduce the length of the block A3 for the robot 10A (the operating time of the robot 10A under the instruction L3) on the screen displayed on the display unit 35 using the input unit 33, as illustrated in FIG. 3B, for example.

In this case, the change determination unit 313 determines that the length of the block has been changed.

In FIGS. 3A and 3B, the user changes the length of the block by operating a touch panel serving as the input unit 33. Alternatively, the user may change the value of the operating time by operating a keyboard or any other similar device serving as the input unit 33, thereby changing the length of the block.

The time calculation unit 314 calculates the operating time of the robot 10 under the instruction corresponding to the changed block based on the changed length of this block.

Specifically, as illustrated in FIG. 3A, the time calculation unit 314 calculates the operating time of the robot 10B under the instruction L2 based on the length of the block B2 for the robot 10B increased by the user. Alternatively, as illustrated in FIG. 3B, the time calculation unit 314 calculates the operating time of the robot 10A under the instruction L3 based on the length of the block A3 for the robot 10A reduced by the user.

The parameter calculation unit 315 calculates the values of one or more parameters including at least either the speed or acceleration satisfying the operating time of the robot 10 calculated by the time calculation unit 314, for example.

Specifically, for example, if the operating time (the length of the block B2) of the robot 10B under the instruction L2 is increased as illustrated in FIG. 3A, the parameter calculation unit 315 calculates the value of the speed at which the robot 10B reaches the teaching point P[2] for the increased operating time within the moving speed range that can be set for the robot 10B (e.g., the range of 1 mm/ms to 2000 mm/ms). For example, if simply changing the speed does not allow the robot 10B to operate for the increased operating time to reach the teaching point P[2], the parameter calculation unit 315 may calculate the value of the acceleration at which the robot 10B reaches the teaching point P[2] for the increased operating time within the acceleration range that can be set for the robot 10B (e.g., the range of 0 mm/ms/ms to 100 mm/ms/ms). Alternatively, the parameter calculation unit 315 may calculate the values of the speed and acceleration at each of which the robot 10B reaches the teaching point P[2] for the increased operating time within the speed range and the acceleration range that can be set for the robot 10B, respectively.

For example, if the operating time of the robot 10A under the instruction L3 (the length of the block A3) is reduced as illustrated in FIG. 3B, the parameter calculation unit 315 calculates the value of the speed at which the robot 10A reaches the teaching point P[3] for the reduced operating time within the moving speed range that can be set for the robot 10A (e.g., the range of 1 mm/ms to 2000 mm/ms). For example, if simply changing the speed does not allow the robot 10A to operate for the reduced operating time to reach the teaching point P[3], the parameter calculation unit 315 may calculate the value of the acceleration at which the robot 10A reaches the teaching point P[3] for the reduced operating time within the acceleration range that can be set for the robot 10A (e.g., the range of 0 mm/ms/ms to 100 mm/ms/ms). Alternatively, the parameter calculation unit 315 may calculate the values of the speed and acceleration at each of which the robot 10A reaches the teaching point P[3] for the reduced operating time within the speed range and the acceleration range that can be set for the robot 10A, respectively.

The change possibility determination unit 316 determines whether or not the length of the block indicated by the user can be changed, based on whether or not the parameter calculation unit 315 has successfully calculated the value(s) of the speed and/or acceleration satisfying the operating time of the robot 10 calculated by the time calculation unit 314.

Specifically, for example, if the parameter calculation unit 315 has successfully calculated the value(s) of the speed and/or acceleration satisfying the operating time of the robot 10 calculated by the time calculation unit 314, the change possibility determination unit 316 determines that the length of the block indicated by the user can be changed. In this case, the change possibility determination unit 316 may make the display unit 35 display a message indicating that “you can change the operating time to the designated value” or any other similar message.

On the other hand, if the parameter calculation unit 315 has not successfully calculated the value(s) of the speed and/or acceleration satisfying the operating time of the robot 10 calculated by the time calculation unit 314, the change possibility determination unit 316 determines that the length of the block indicated by the user cannot be changed. In this case, the change possibility determination unit 316 may make the display unit 35 display a message indicating that “you cannot change the operating time to the designated value” or any other similar message. In addition, the change possibility determination unit 316 may calculate the value(s) of the speed and/or acceleration that allows the operating time to be closest to that calculated by the time calculation unit 314 within the moving speed range (e.g., the range of 1 mm/ms to 2000 mm/ms) and/or the acceleration range (e.g., the range of 0 mm/ms/ms to 100 mm/ms/ms) that can be set for the robot 10. The change possibility determination unit 316 may make the display unit 35 display (update) a block indicating the operating time of the robot 10 at the calculated value(s) of the speed and/or acceleration.

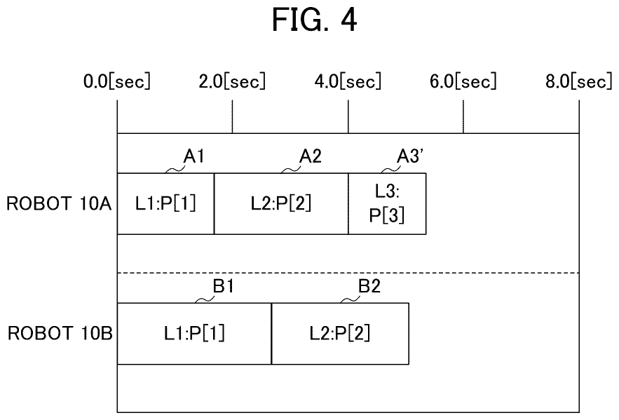

FIG. 4 illustrates an example of a block A3′ indicating the operating time closest to the calculated operating time.

In this case, in one preferred embodiment, the change possibility determination unit 316 accepts an indication as to whether or not the operating time is to be corrected to the closest operating time indicated by the block A3′ on the screen in FIG. 4 from the user via the input unit 33.

For example, if the change possibility determination unit 316 determines that the length of the block indicated by the user can be changed, the program correction unit 317 corrects the program (robot program) using the value(s) of the speed and/or acceleration calculated by the parameter calculation unit 315.

On the other hand, if the change possibility determination unit 316 determines that the length of the block cannot be changed to that indicated by the user, and the indication to correct the operating time to the closest operating time calculated by the change possibility determination unit 316 is accepted from the user as illustrated in FIG. 4, the program correction unit 317 corrects the program (robot program) using the value(s) of the speed and/or acceleration that allows the operating time to be closest to that calculated by the change possibility determination unit 316.

If the change possibility determination unit 316 determines that the length of the block cannot be changed to that indicated by the user, and the indication to correct the operating time to the closest operating time calculated by the change possibility determination unit 316 is not accepted from the user, the program correction unit 317 does not correct the program (robot program).

The program output unit 318 outputs the program (robot program) corrected by the program correction unit 317 to the associated control device 20.

### <Teaching Assistance Process to be Performed by Program Teaching Assistance Device 30>

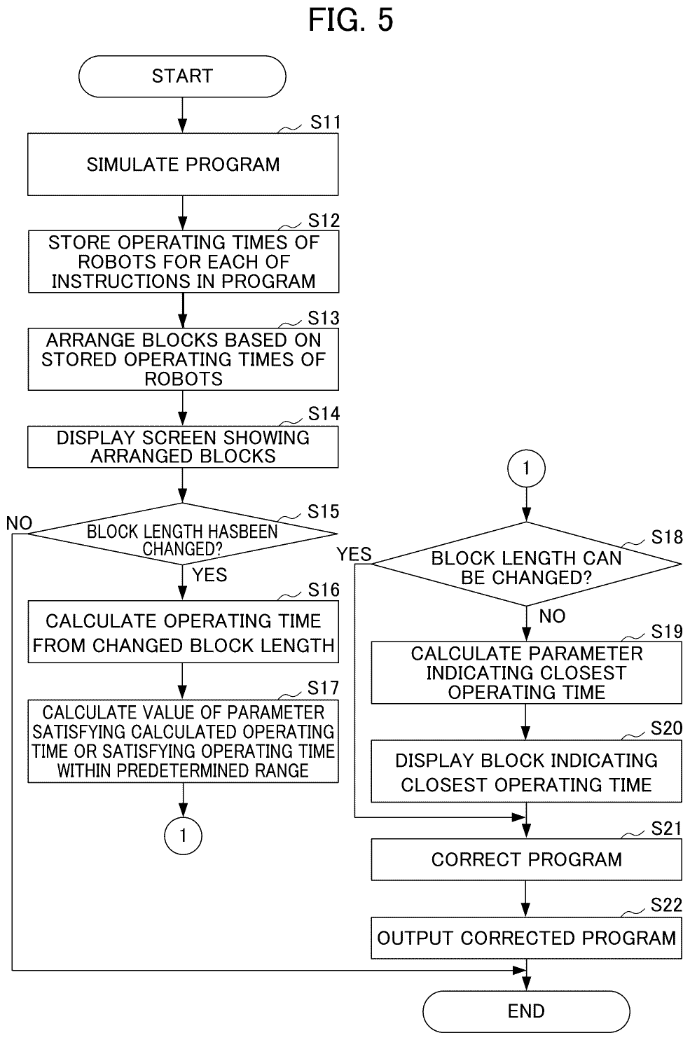

Next, the flow of a teaching assistance process to be performed by the program teaching assistance device 30 will be described with reference to FIG. 5.

FIG. 5 is a flowchart illustrating the teaching assistance process to be performed by the program teaching assistance device 30. The flow shown here is executed every time a program (robot program) is loaded.

In Step S11, the simulation execution unit 311 simulates programs loaded from the control devices 20 by the program input unit 310.

In Step S12, the simulation execution unit 311 makes the time storage unit 371 store, for each of the robots 10, operating times of the robots 10 for each of instructions in the associated programs.

In Step S13, the arrangement unit 312 arranges blocks along the time axis on an instruction-by-instruction basis and/or in instruction order in the program, based on the operating times stored in Step S12. The blocks each indicate the operating time of the robot 10.

In Step S14, the arrangement unit 312 makes the display unit 35 display a screen showing the arranged blocks.

In Step S15, the change determination unit 313 determines whether or not a user has changed the length of any one of the blocks displayed on the display unit 35 via the input unit 33. If the length of the block has been changed, the process proceeds to Step S16. On the other hand, if the length of the block has not been changed, the program teaching assistance device 30 ends the teaching assistance process.

In Step S16, the time calculation unit 314 calculates the operating time of the robot 10 under an instruction corresponding to the block changed in Step S15, based on the length of this block.

In Step S17, the parameter calculation unit 315 calculates the values of one or more parameters indicating the speed and/or acceleration satisfying the operating time of the robot 10 calculated in Step S16.

In Step S18, the change possibility determination unit 316 determines whether or not the length of the block indicated in Step S15 can be changed, based on whether or not the value(s) of the speed and/or acceleration satisfying the operating time of the robot 10 calculated in Step S16 has been successfully calculated in Step S17. If the value(s) of the speed and/or acceleration satisfying the operating time of the robot 10 calculated in Step S16 have been successfully calculated in Step S17, the change possibility determination unit 316 determines that the length of the block indicated in Step S15 can be changed. Then, the process proceeds to Step S21.

On the other hand, if the value(s) of the speed and/or acceleration satisfying the operating time of the robot 10 calculated in Step S16 has not been successfully calculated in Step S17, the change possibility determination unit 316 determines that the length of the block indicated in Step S15 cannot be changed. Then, the process proceeds to Step S19.

In Step S19, the change possibility determination unit 316 calculates the values of the one or more parameters indicating the speed and/or acceleration that allows the operating time to be closest to the operating time calculated in Step S16 within the moving speed range and/or the acceleration range that can be set for the robot 10.

In Step S20, the change possibility determination unit 316 makes the display unit 35 display (update) a block indicating the operating time of the robot 10 at the value(s) of the speed and/or acceleration calculated in Step S19.

In Step S21, the program correction unit 317 corrects the program (robot program) using the value(s) of the speed and/or acceleration calculated in Step S16. If a determination is made in Step S18 that the length of the block cannot be changed to that indicated, and the indication to correct the operating time to the closest operating time calculated in Step S19 is accepted from the user, the program correction unit 317 corrects the program (robot program) using the value(s) of the speed and/or acceleration that allows the operating time to be equal to the closest operating time calculated in Step S19.

In Step S22, the program output unit 318 outputs the program (robot program) corrected in Step S21 to the associated control device 20.

As can be seen from the foregoing description, the program teaching assistance device 30 according to the embodiment simulates the programs to determine different operating times of the robots 10 for different instructions, and arranges the blocks, each indicating the determined operating time for the associated instruction, along the time axis on an instruction-by-instruction basis or in instruction order. If the user has changed the length of the block, the program teaching assistance device 30 calculates the values of the one or more parameters indicating the speed and/or acceleration so that the operating time corresponds to the changed length of the block, and thus corrects the program. Thus, the use of the program teaching assistance device 30 allows an inexperienced user to also easily adjust the time taken to reach the target position through the program.

Displaying the screen where the blocks indicating different operating times for different instructions are arranged along the time axis allows the user to more easily recognize the time proportion of each of operations in the (entire) cycle time of the program (robot program).

The length (size) of each block directly linked to the operating time allows the user to correct the operating time by intuition. This can reduce man-hours for program (robot program) teaching.

The embodiment has been described above. However, the program teaching assistance device 30 should not be limited to the above-described embodiment, and includes variations and improvements as long as the object can be achieved.

### <First Variation>

In the embodiment, the program teaching assistance device 30 is different from the control devices 20. However, this is merely an example. For example, the program teaching assistance device 30 may be included in each control device 20.

Alternatively, a server, for example, may include some or all of the program input unit 310, the simulation execution unit 311, the arrangement unit 312, the change determination unit 313, the time calculation unit 314, the parameter calculation unit 315, the change possibility determination unit 316, the program correction unit 317, and the program output unit 318 of the program teaching assistance device 30. A virtual server function or any other function may be used on the cloud to implement the functions of the program teaching assistance device 30.

In addition, the program teaching assistance device 30 may be a distributed processing system that distributes the functions of the program teaching assistance device 30 among a plurality of servers as appropriate.

### <Second Variation>

For example, the parameter calculation unit 315 calculates the value(s) of the speed and/or acceleration satisfying the operating time of the robot 10 calculated by the time calculation unit 314. However, this is merely an example.

For example, the parameter calculation unit 315 may calculate the value(s) of the speed and/or acceleration satisfying the operating time of the robot 10 calculated by the time calculation unit 314 within a predetermined range. In this case, the parameter calculation unit 315 may calculate the value(s) of the speed and/or acceleration satisfying the operating time of the robot 10 that has been calculated by the time calculation unit 314 and that is closest to that required by the user.

### <Third Variation>

For example, in the foregoing embodiment, if the user has changed the length of the block, the parameter calculation unit 315 calculates the values of the one or more parameters indicating the speed and/or acceleration so that the operating time corresponds to the changed length of the block. However, this is merely an example. For example, if the user has changed the length of the block, the parameter calculation unit 315 may calculate the values of parameters indicating an override value or any other value as well as the speed and/or acceleration so that the operating time corresponds to the changed length of the block.

If the control devices 20 are numerical control devices that control a machine tool or any other tool, and the user has changed the length of the block, the parameter calculation unit 315 may calculate the value of any one of the parameters, such as the speed, the acceleration, or the jerk, so that the operating time corresponds to the changed length of the block.

### <Fourth Variation>

For example, in the foregoing embodiment, if the user has changed the length of the block, the program teaching assistance device 30 calculates the values of the one or more parameters indicating the speed and/or acceleration so that the operating time corresponds to the changed length of the block. However, this is merely an example.

For example, if no interference is present around the robot 10, and a path along which the robot 10 operates is thus ignorable, the program teaching assistance device 30 may further treat the format of operation of the robot, such as “Each Axis”, “Straight Line”, and “Arc”, and the format of positioning as parameter candidates satisfying the changed operating time.

The functions included in the program teaching assistance device 30 according to the embodiment can be each implemented by hardware, software, or a combination of hardware and software. In this regard, the wording “implemented by software” means being implemented by a computer reading a program.

The program can be stored using various types of non-transitory computer readable media, and can be supplied to the computer. The non-transitory computer readable media include various types of tangible storage media. Examples of the non-transitory computer readable media include a magnetic recording medium (e.g., a flexible disk, a magnetic tape, and a hard disk drive), a magneto-optical recording medium (e.g., a magneto-optical disk), a CD read only memory (CD-ROM), a CD-R, a CD-R/W, and a semiconductor memory (e.g., a mask ROM, a programmable ROM (PROM), an erasable PROM (EPROM), a flash ROM, and a RAM). The program may also be supplied to the computer by various types of transitory computer readable media. Examples of the transitory computer readable media include an electric signal, an optical signal, and an electromagnetic wave. The transitory computer readable medium can supply the program to the computer via a wired communication path, such as an electric wire or an optical fiber, or via a wireless communication path.

Note that the step of describing the program stored in the recording medium includes, needless to say, not only processing performed in chronological order but also processing not necessarily performed in chronological order but executed in parallel or individually.

In other words, the program teaching assistance device of the present disclosure can be implemented as various embodiments having the following features.

(1) The program teaching assistance device 30 of the present disclosure includes a display unit 35 configured to display the operating times of a robot 10 calculated on each of instructions and/or in instruction order in a program in the form of arranged blocks whose length of the operating times is variable.

The use of this program teaching assistance device 30 allows an inexperienced user to also easily adjust the time taken to reach the target position through the program.

(2) The program teaching assistance device 30 according to the feature (1) may further include a program input unit 310 configured to receive the program, a simulation execution unit 311 configured to simulate the program, a time storage unit 371 configured to store the operating time for each instruction based on simulation results of the robot 10, and an arrangement unit 312 configured to arrange the blocks based on the operating times stored in the time storage unit 371.

This allows the user to easily determine which block indicates the operating time that should be adjusted.

(3) The program teaching assistance device 30 according to the feature (1) or (2) may further include a change determination unit 313 configured to determine whether or not the length of the block has been changed, and a time calculation unit 314 configured to calculate the operating time of the robot 10 under an instruction corresponding to the changed block based on the changed length of the block.

This allows the program teaching assistance device 30 to easily calculate the operating time of the robot 10 adapted to the changed length of the block.

(4) The program teaching assistance device 30 according to the feature (3) may further include a parameter calculation unit 315 configured to calculate the values of one or more parameters including at least either the speed or acceleration satisfying the operating time of the robot 10 calculated by the time calculation unit 314, and a program correction unit 317 configured to correct the program using the value of the parameter calculated by the parameter calculation unit 315.

Thus, the user simply changing the length of the block allows the program teaching assistance device 30 to correct the program so that the operating time of the robot 10 corresponds to the changed length of the block.

(5) The program teaching assistance device 30 according to the feature (4) may further include a change possibility determination unit 316 configured to determine whether or not the length of the block can be changed, based on whether or not the parameter calculation unit 315 has successfully calculated the value of the parameter satisfying the operating time of the robot 10 calculated by the time calculation unit 314.

This allows the program teaching assistance device 30 to prevent the program in which an inappropriate parameter has been set from being output to a control device 20.

(6) In the program teaching assistance device 30 according to the feature (5), in a case where the value of the parameter satisfying the operating time of the industrial machine has not been successfully calculated, the change possibility determination unit 316 may calculate the value of the parameter that allows the operating time to be closest to the operating time of the industrial machine calculated by the time calculation unit 314, and may make the display unit 35 display the block indicating the operating time of the industrial machine at the value of the calculated parameter.

This allows the program teaching assistance device 30 to reliably adjust the time taken to reach the target position.

### EXPLANATION OF REFERENCE NUMERALS

1 Machine System
10A, 10B Robot
20A, 20B Control Device
30 Program Teaching Assistance Device
31 Control Unit
310 Program Input Unit
311 Simulation Execution Unit
312 Arrangement Unit
313 Change Determination Unit
314 Time Calculation Unit
315 Parameter Calculation Unit
316 Change Possibility Determination Unit
317 Program Correction Unit
318 Program Output Unit
33 Input Unit
35 Display Unit
37 Storage Unit
371 Time Storage Unit

1. A program teaching assistance device comprising:
a display unit configured to display operating times of an industrial machine calculated on each of instructions and/or in instruction order in a program in a form of arranged blocks whose length of the operating times is variable.

2. The program teaching assistance device according to claim 1 further comprising:
a program input unit configured to receive the program;
a simulation execution unit configured to simulate the program;
a time storage unit configured to store the operating time for each instruction, based on simulation results of the industrial machine; and
an arrangement unit configured to arrange the blocks based on the operating times stored in the time storage unit.

3. The program teaching assistance device according to claim 1 further comprising:
a change determination unit configured to determine whether or not one of the blocks has had a length changed; and
a time calculation unit configured to calculate the operating time of the industrial machine under the instruction corresponding to the one of the blocks based on the changed length of the block.

4. The program teaching assistance device according to claim 3 further comprising:
a parameter calculation unit configured to calculate values of one or more parameters including at least either a speed or an acceleration satisfying the operating time of the industrial machine calculated by the time calculation unit; and
a program correction unit configured to correct the program using the values of the one or more parameters calculated by the parameter calculation unit.

5. The program teaching assistance device according to claim 4 further comprising:
a change possibility determination unit configured to determine whether or not the length of the block can be changed, based on whether or not the parameter calculation unit has successfully calculated the values of the one or more parameters satisfying the operating time of the industrial machine calculated by the time calculation unit.

6. The program teaching assistance device according to claim 5, wherein
in a case where the values of the one or more parameters satisfying the operating time of the industrial machine have not been successfully calculated, the change possibility determination unit calculates the values of the one or more parameters that allow the operating time to be closest to the operating time of the industrial machine calculated by the time calculation unit, and makes the display unit display the block indicating the operating time of the industrial machine at the calculated values of the one or more parameters.
